(19) United States
(12) Patent Application Publication
(10) Pub. No.: US 2023/0158865 A1
(43) Pub. Date: May 25, 2023

(54) SYSTEM AND METHOD FOR SMART WINSHIELD IN VEHICLES

(71) Applicant: Sean H. Schwartz, Ashburn, VA (US)

(72) Inventor: Sean H. Schwartz, Ashburn, VA (US)

(21) Appl. No.: 17/992,472

(22) Filed: Nov. 22, 2022

Related U.S. Application Data
(60) Provisional application No. 63/282,308, filed on Nov. 23, 2021.

(51) Int. Cl. B60J 3/04; B60J 3/02; B60J 1/20

(52) U.S. Cl. CPC B60J 3/04; B60J 1/20; B60J 3/02

(57) ABSTRACT

The present teaching relates to approaches for dynamic light blocking in a moving vehicle. Sensor data from sensors deployed on a vehicle are received that capture information exterior and interior around the vehicle. The presence of a person in the vehicle is detected based on interior sensor data while a light source exterior to the vehicle is detected based on exterior sensor data. A portion of a window of the vehicle through which light from the light source shines on the person is determined and an appropriate level of shade is applied on the portion of the window to reduce the amount of light shining on the person.

### CROSS REFERENCE TO RELATED APPLICATION

This application claims the benefit of U.S. Provisional Pat. Application No. 63/282,308, filed Nov. 23, 2021, the contents of which are hereby incorporated by reference in its entirety.

### BACKGROUND

### 1. Technical Field

The present teaching generally relates to automated control. More specifically, the present teaching relates to smart vehicle windshield.

### 2. Technical Background

With the development of the computing technologies and electronics, devices and industrial parts are increasingly controlled automatically. Criteria used in such automatic controls are generally application and/or situation dependent. With the advancement of miniaturized electronics and substantially enhanced sensing technologies and computation power, algorithms based on artificial intelligence have been used to implement automatic controls in a variety of situations, some in real-time based on observed even changing situations. However, there are still many situations in which situation-based controls are still done manually without much machine intelligence.

FIG. 1A shows a scene in a moving vehicle 100, which may be a car, a truck, or a boat, with a front transparent window 130 that allows a vehicle operator to see what is in front of the vehicle in order to react to the operating situation. In this illustrated example, there are two seats, including one for a driver (or operator) 110 and a passenger seat 120. Both the driver and the passenger can see the front of the vehicle through the front window 130. Depending on the time of the driving and the direction the vehicle is heading, the sun may appear in front of the vehicle and its directions may change. This is illustrated in FIG. 1A, where the sun may be at position 140-1 (in straight front of the vehicle) or at position 140-2 (towards the right side of the vehicle).

It is commonly known that when the sun appears in front of a vehicle, it can cause glare, making it difficult to drive because a driver cannot see clearly what is in front of the vehicle. Sun glare can be dangerous because it may cause the driver to react to a situation slower than it needs to be, sometimes causing accident. Although some vehicles do provide shields so that when it is pulled down, it may block the sun glare. This is shown in FIG. 1B, where shield 150 is pulled down in this illustration to block the sun light in front of the vehicle. But such shields are usually installed as a fixture or partially fixture so that it can be placed only within some limited range so that it can block the sun light that is from only some limited angles. That is, if the sun light is from a direction not within such limited angles, the shield 150 will not be block the sun light. This can be seen in FIG. 1C. If the sun is in the direction of 140-5, shield 150, when pulled down as shown, may be able to block the sun light. However, if there is a passenger on the other side of the vehicle, pulling down the shield on the passenger side will not be able to block the sun light from position 140-5, causing discomfort to the passenger. On the other hand, if the sun is at direction 140-4, shield 150 can block at best partially. In addition, if the sun is at position 140-3, although it will not shine directly in the driver’s eyes, it may still cause discomfort to many.

The problems with the current means in vehicles to block sun light have been known for years and different solutions have been attempted, including providing tinted windows. However, the traffic laws in most countries do not allow vehicles with such tinted windows, especially the front window. FIG. 1D shows another solution, which corresponds to a light mesh 160 that is big enough to cover a much larger portion of the front window. However, this big mesh, although light, is not affixed on the dashboard (making it possible to fall off at any time) and must be manually placed on the dashboard. Due to its size, placing it at where it needs to be can be awkward. In addition, it still cannot be placed on the driver side because it can fall off making it dangerous. Given that it is not affixed to the vehicle, it also increases the risk of causing accident.

Thus, there is a need for a solution that address the shortcomings of and enhance the effectiveness of the traditional solutions.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform for control dynamic light blocking is disclosed. Sensor data from sensors deployed on a vehicle are received that capture information exterior and interior around the vehicle. The presence of a person in the vehicle is detected based on interior sensor data while a light source exterior to the vehicle is detected based on exterior sensor data. A portion of a window of the vehicle through which light from the light source shines on the person is determined and an appropriate level of shade is applied on the portion of the window to reduce the amount of light shining on the person.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for dynamic light blocking. Sensor data from sensors deployed on a vehicle are received that capture information exterior and interior around the vehicle. The presence of a person in the vehicle is detected based on interior sensor data while a light source exterior to the vehicle is detected based on exterior sensor data. A portion of a window of the vehicle through which light from the light source shines on the person is determined and an appropriate level of shade is applied on the portion of the window to reduce the amount of light shining on the person.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1A -1D show examples of prior solutions;

FIGS. 2A-2J depict different configurations of shield positions for blocking sun light for different seats with respect to different directions of the sun;

FIGS. 3A-3C show exemplary layout of a window of a vehicle with individually controllable elements for blocking sun light in different situations, in accordance with an embodiment of the present teaching;

FIG. 4A depicts an exemplary configuration to detecting the direction of the sun and that of a person in a vehicle, in accordance with an exemplary embodiment of the present teaching;

FIG. 4B illustrates exemplary measures related to a person observed;

FIG. 4C illustrates using bounding boxes to identify relevant rays of sight between a person and the sun, in accordance with an embodiment of the present teaching;

FIG. 4D illustrates how appropriate sections of a front window in a vehicle may be determined for blocking sun light to a person in the vehicle, in accordance with an embodiment of the present teaching;

FIG. 5A depicts an exemplary high-level system diagram of an automated mechanism for adaptive sun block shield, in accordance with an exemplary embodiment of the present teaching;

FIG. 5B is a flowchart of an exemplary process of an automated mechanism for adaptive sun block shield, in accordance with an exemplary embodiment of the present teaching;

FIG. 6A depicts an exemplary high-level system diagram of a face/sun spatial relationship detector, in accordance with an exemplary embodiment of the present teaching;

FIG. 6B is a flowchart of an exemplary process of a face/sun spatial relationship detector, in accordance with an exemplary embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

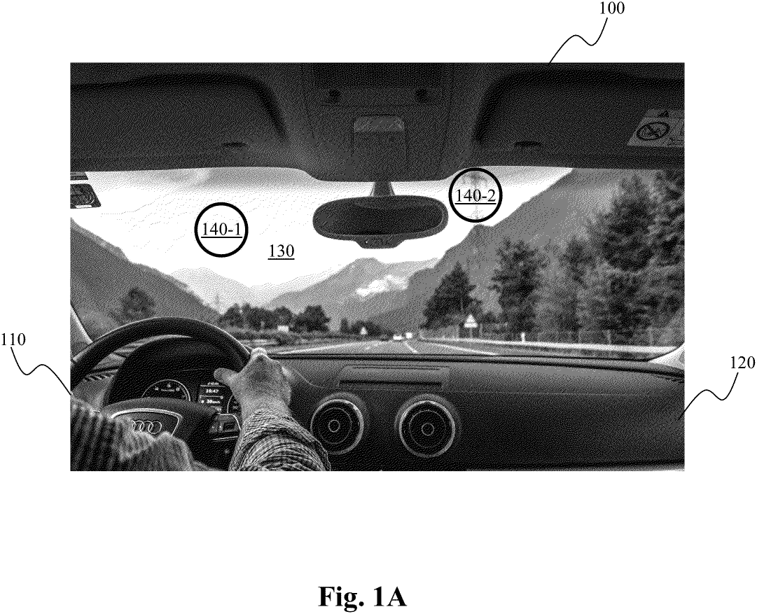

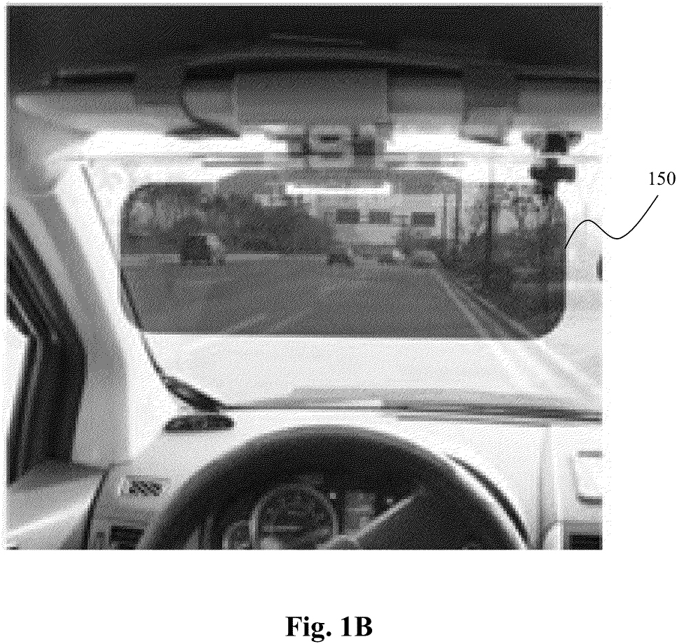

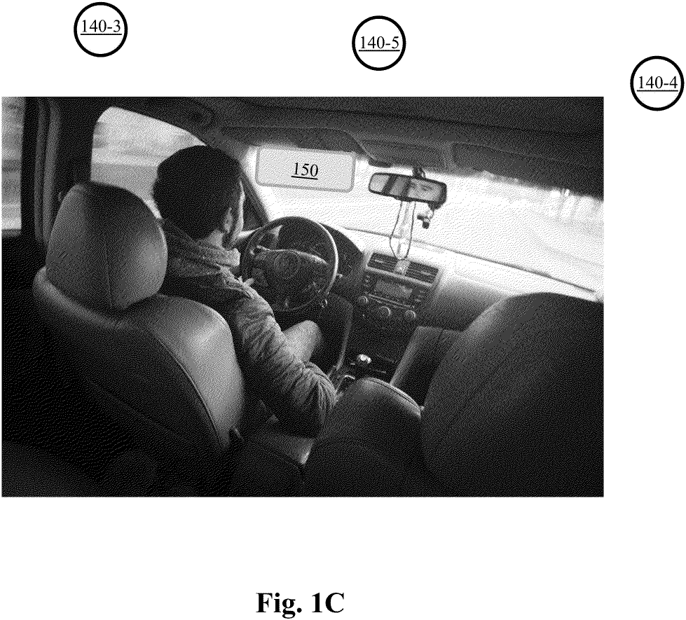

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching aims to address the deficiencies of the current state of art in a windshield for blocking unwanted light in moving vehicles. According to the present teaching, a window is made with a plurality of sections, each of which may be individually configured to provide a certain level of tint so that the amount of light from a source that is allowed to go through the section can be controlled based on need. The source of light may be natural or artificial. The level of tint to be applied to block the light may be configured based on preferences specified on how much light is desired. The level of tint to be provided may also be determined based on the strength of light observed which may be estimated based on different means. For example, for sun light observed during the daytime, the strength of the light shining on the window may be estimated based on sensor information (e.g., visual information or heat information) or alternatively a time of the day. If it involves light from an artificial source (e.g., light for a construction site), the strength of the light may be determined from sensor information or information communicated to the vehicle (e.g., such information may be broadcast to the passing vehicles).

Sections of the window are to be selected to provide needed level of tint may be determined dynamically based on each specific situation. For example, a direction of the sun may be dynamically determined with respect to a person who desires to block the sun light so that sections that are between the sun and the person may be identified. Connecting the direction of the source of the light shining on the window and the direction of a person in the vehicle, it may be determined as to which sections on the window that are on the intersection course and which sections nearby the intersection course may also be tinted to provide an adequate coverage. Then a certain level of tint to be applied may also be estimated based on, e.g., a personalized configuration specifying a comfort level on the light.

With relevant sections on the window identified and a level of tint determined to satisfy the specified comfort level, the tint is then applied to the identified sections by controlling each identified sections to be tinted accordingly so that the amount of the light shining through the sections of the window provides the person the desired level of comfort. The level of tint for each person may vary and may be configured based on preference of the person in a personalized manner. In a dynamic situation, each person may be recognized via, e.g., face recognition or other means, so that an appropriate configuration associated with the recognized person may be invoked to implement a personalized light shielding.

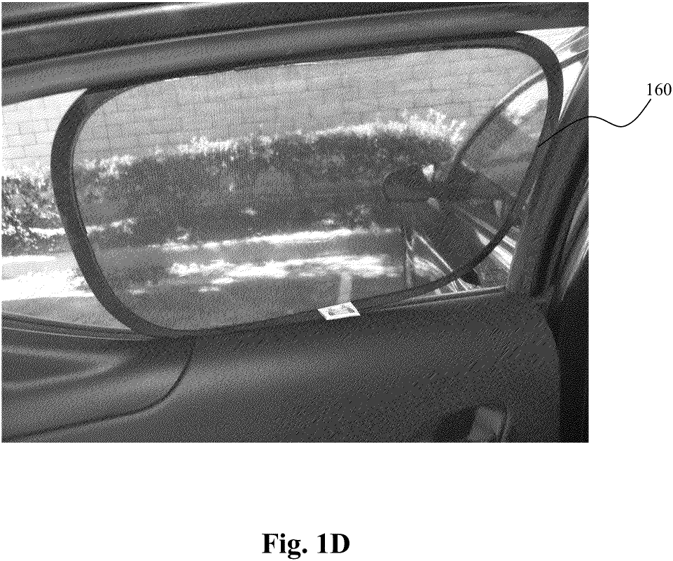

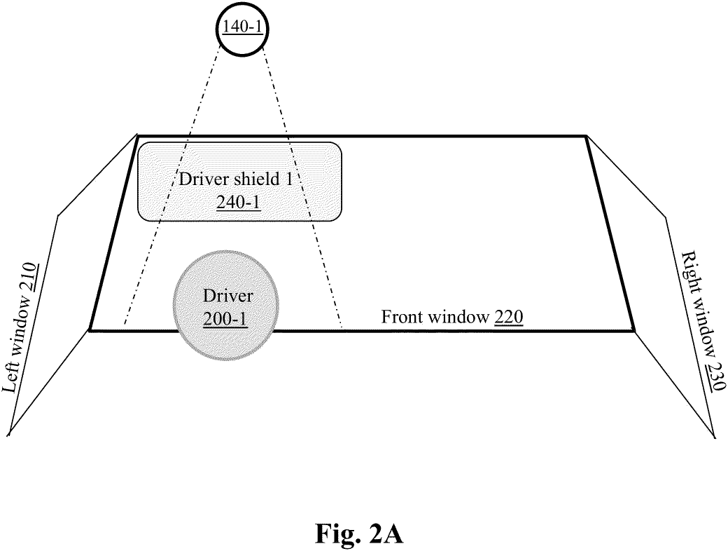

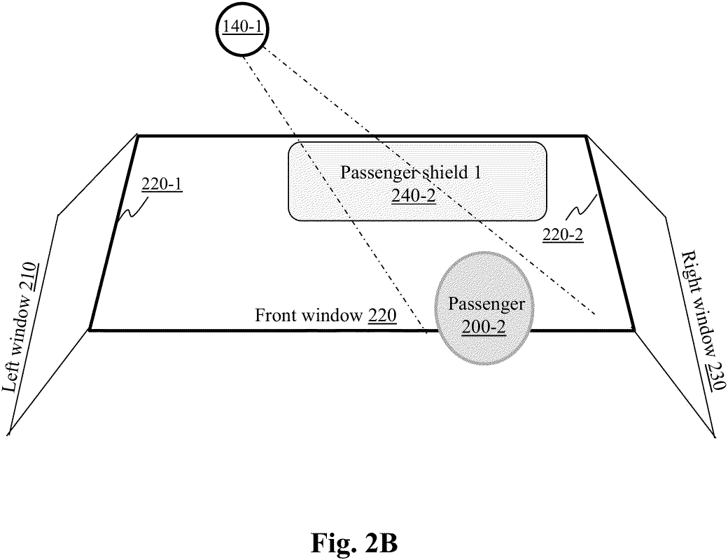

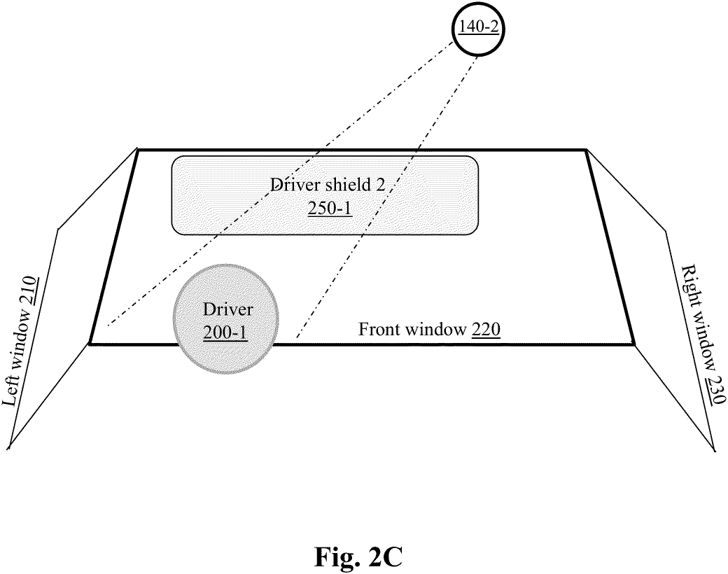

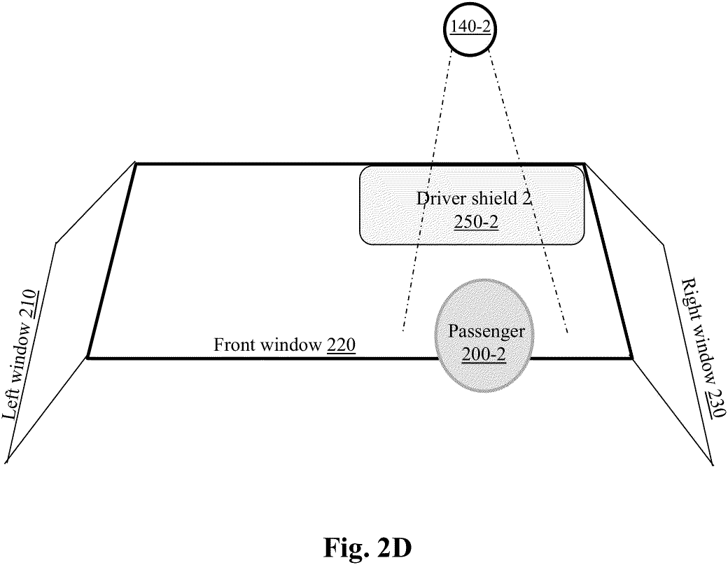

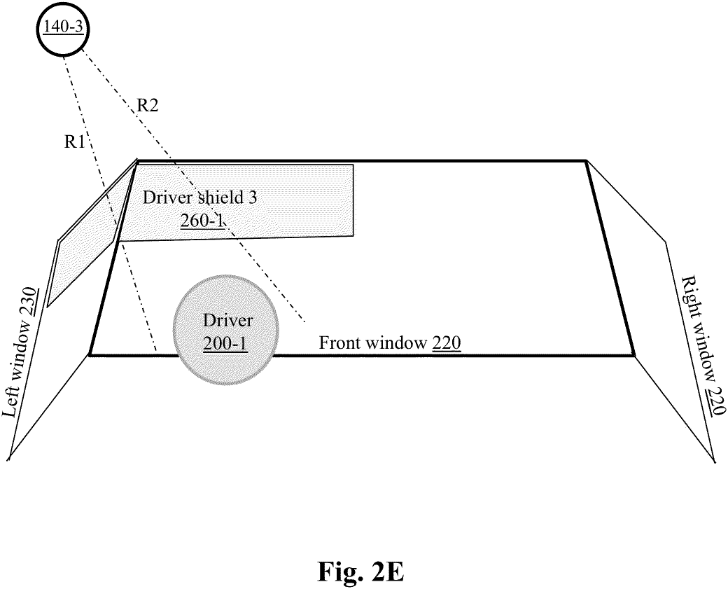

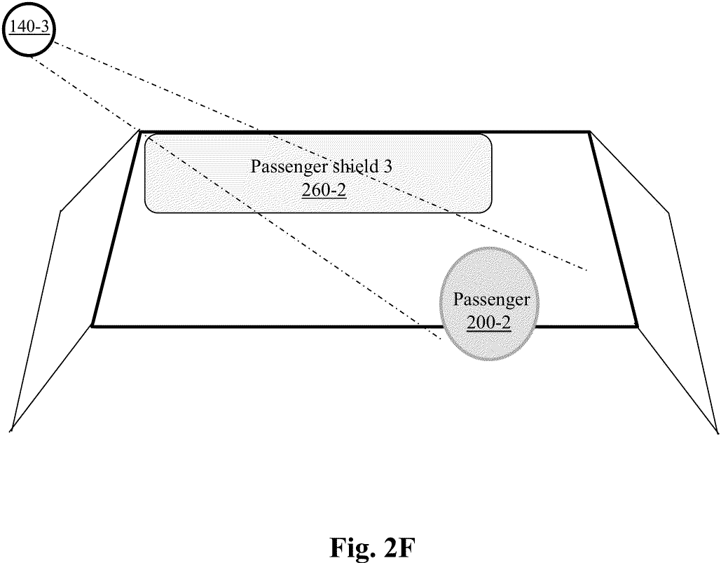

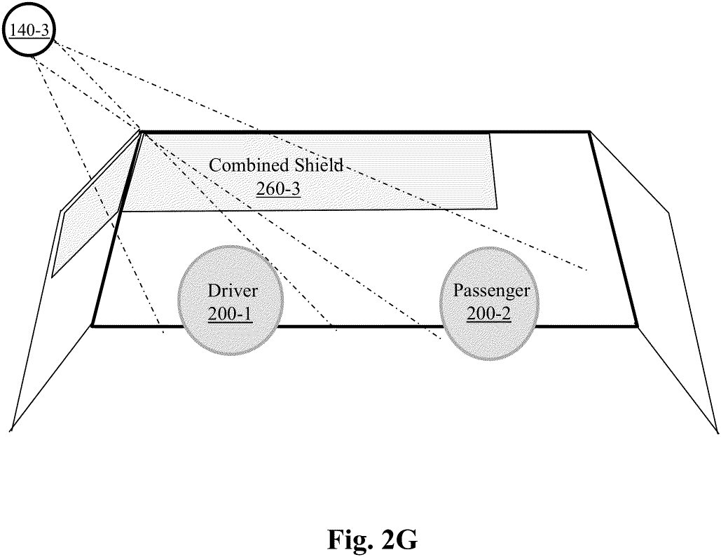

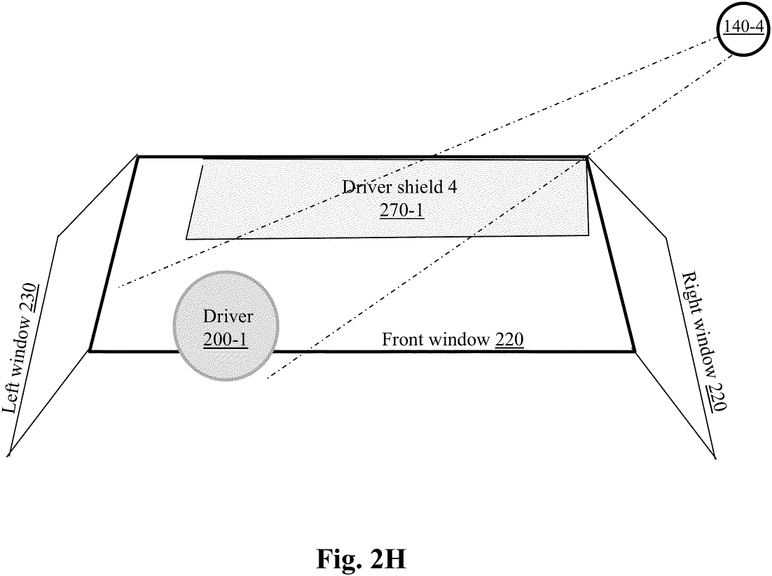

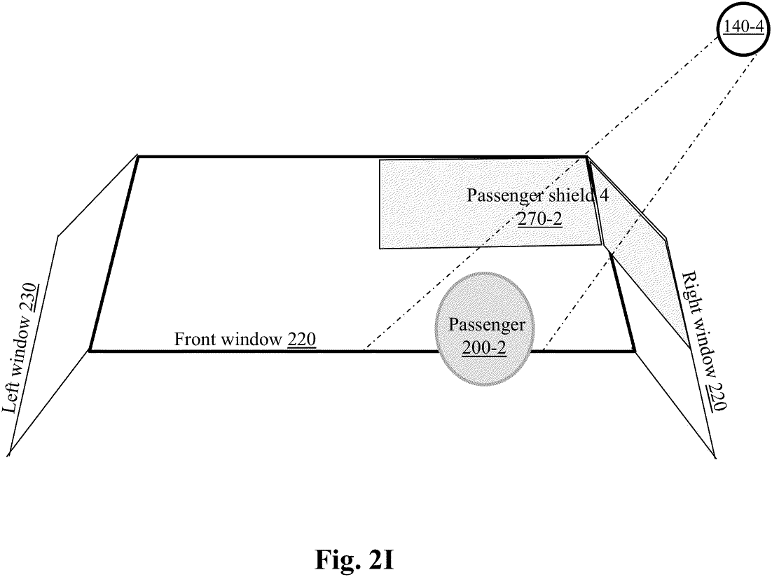

FIGS. 2A-2J depict different configurations of shield positions for blocking sun light for different seats with respect to different directions of the sun. In FIG. 2A, a front portion of a vehicle is shown with a front window 220, a left window 210, and a right window 230. The front window 220 and the left window 210 intersect at a first edge 220-1 and the front window 220 and the right window 230 intersect at a second edge 220-2. For the light from sun 140-1 in the direct front of the driver 200-1 in the vehicle, a driver shield 1 240-1 is needed to block the sun glare shining through a front window 220. FIG. 2B shows the position and size of a passenger shield 1 240-2 needed to block the sun light from 140-1 shining to a passenger in the same vehicle. It is observed that the driver shield 1 240-1 and the passenger shield 1 240-2 may not be the same size and may be configured differently with respect to the edge of the vehicle. For example, the driver shield 1 240-1 may start from the first edge 220-1 but the passenger shield 1 240-2 may not be right next to the nearby edge, i.e., second edge 220-2; the driver shield 1 240-1 may be of a smaller size than that of the passenger shield 1 240-2. Such differences are due to the dynamic determination as to what sections on the front window need to be tinted in order to block the sun light 140-1 from shining on the associated person.

FIGS. 2C - 2D show the driver shield 2 250-1 and passenger shield 2 250-2 needed to prevent sun light 140-2 at a different spatial position from shining on driver 200-1 and passenger 200-2, respectively. Driver shield 2 250-1 is determined based on what is needed to block the light shining on a part of driver 200-1 with respect to the direction of the sun 140-2. Similarly, passenger shield 2 250-2 for the passenger is determined based on what is needed to block the light shining on a part of passenger 200-2 with respect to the direction of the sun 140-2. The size of the driver shield 2 250-1 may differ from that of the passenger shield 2 250-2. The size needed for each person may also be determined based on a preference specified by the driver or passenger, respectively, e.g., on how big the area the person desires to block the sun.

FIGS. 2E - 2F show the driver shield 3 260-1 and passenger shield 3 260-2 needed to prevent sun light 140-3 at the shown direction from shining on driver 200-1 and passenger 200-2, respectively. In this exemplary situation, the sun 140-3 is from the left side of the vehicle as shown in the figures. Given that, providing a shield on only the front window 220 is not adequate because the sun light will shine on the left face of the driver. It is a commonly experienced situation where a merely front shield is not adequate and does not provide the comfort level needed to many. As illustrated, the present teaching is to provide, to driver 200-1, adequate shielding coverage by expanding the driver shield 3 260-1 to include a part of both the front window and the life window so that the driver shield 3 260-1 block the sun light 140-3 from necessary directions. That is, a certain portion of the left window 210 may also be tinted as a part of the driver shield 3 260-1 as needed to block the light shining on driver 200-1. The size of the portions on each window may be determined based on the preference of the driver as to coverage. In some embodiments, it may also be determined based on, e.g., local regulations as to traffic law. For example, it may not be allowed in some states to fully tint some of the windows on a vehicle (e.g., front window).

Similarly, passenger shield 3 260-2 for the passenger is determined based on what is needed to block the light shining on passenger 200-2 with respect to the direction of the sun 140-3. As can be seen, due to the direction of the sun, the passenger shield 3 260-2 is mostly located on the side of the front window right in front of the driver 220-1. Given that, the driver shield 260-1 and the passenger shield 3 260-2 may have substantial overlap and, in some embodiments, the two shields determined for two different people in the vehicle (if they both are present) may be merged into one that can be used to block the sun light 140-3 in the left of the vehicle for both people in the vehicle. This is illustrated in FIG. 2G, where the combined shield 260-3 provides a tinted region in the front window 220 and a tinted region on the left window 210 which together blocks the sun light from the direction 140-3.

FIGS. 2H - 2J present configuration for another scenario in which the sun 140-4 is in the direction of right side of the vehicle. To block the light for the driver 200-1, driver shield 4 270-1 may be configured on the front window as shown in FIG. 2H. As the sun is on the right side of the vehicle, to block the sun light for the passenger, the passenger shield 4 270-2 extends from the front window 220 also into the right window 230. This is shown in FIG. 2I. When both the driver 200-1 and the passenger 200-2 are present in the vehicle and desire to block sun light, the driver shield 4 270-1 and the passenger shield 4 270-2 may be combined to form a combined shield 270-3 as shown in FIG. 2J.

As discussed herein, a window according to the present teaching comprises a plurality of sections, each of which is individually activatable to be a part of a shield to be implemented by increasing the tint level. Any section can be selected if it is on the intercept paths of rays connecting the sun and the part of the body of a person for whom the sun light is to be blocked. Such selected sections together form a shield dynamically based on need. Different illustrated shields as illustrated in FIGS. 2A - 2J, whether for blocking the sun light for the driver 200-1 or for the passenger 200-2, are formed based on such selected sections.

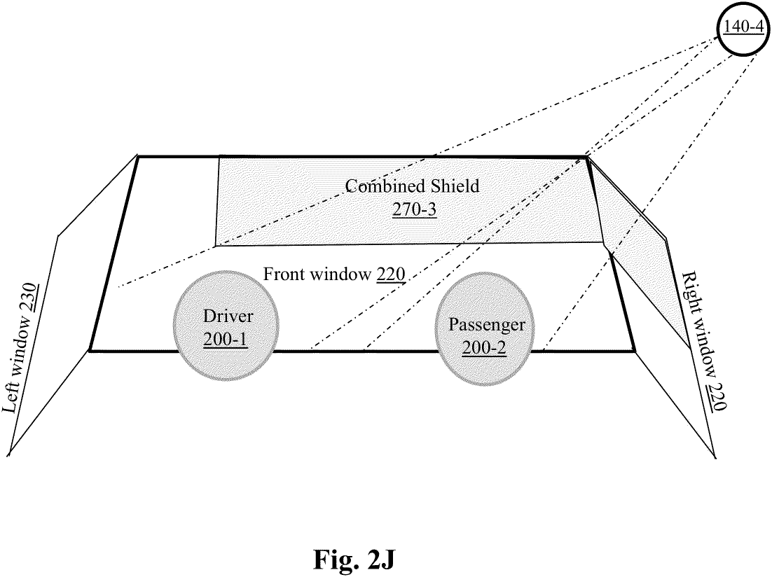

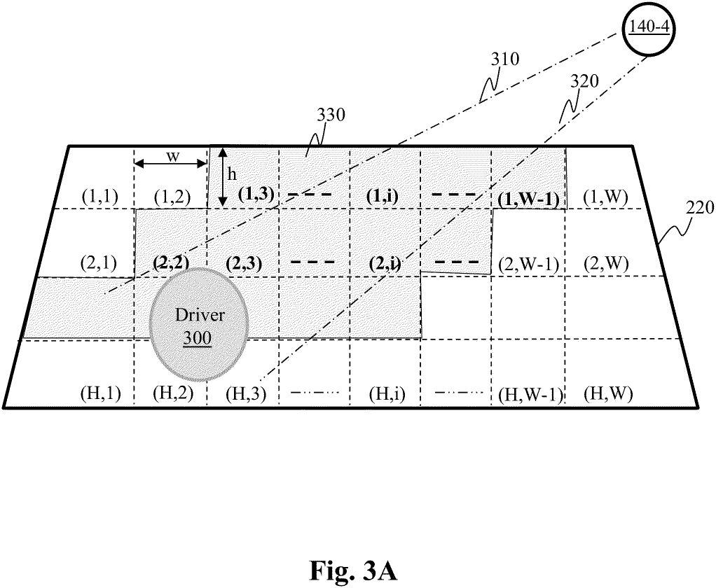

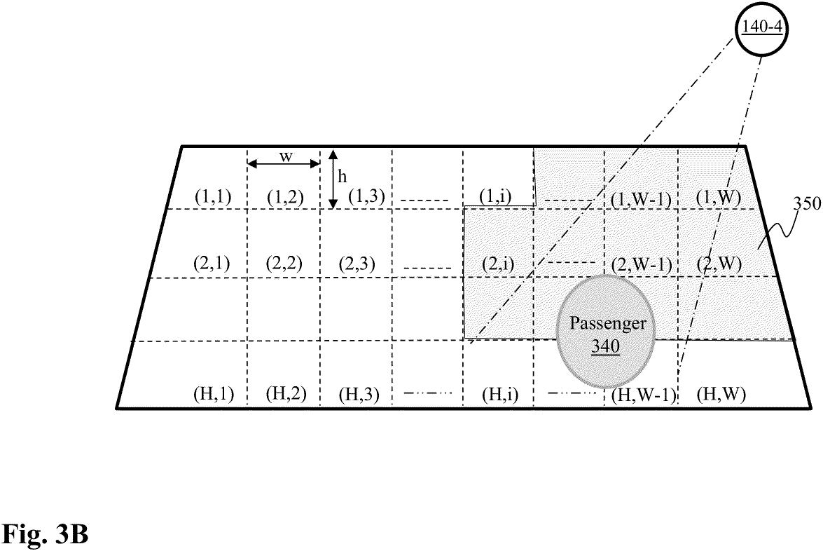

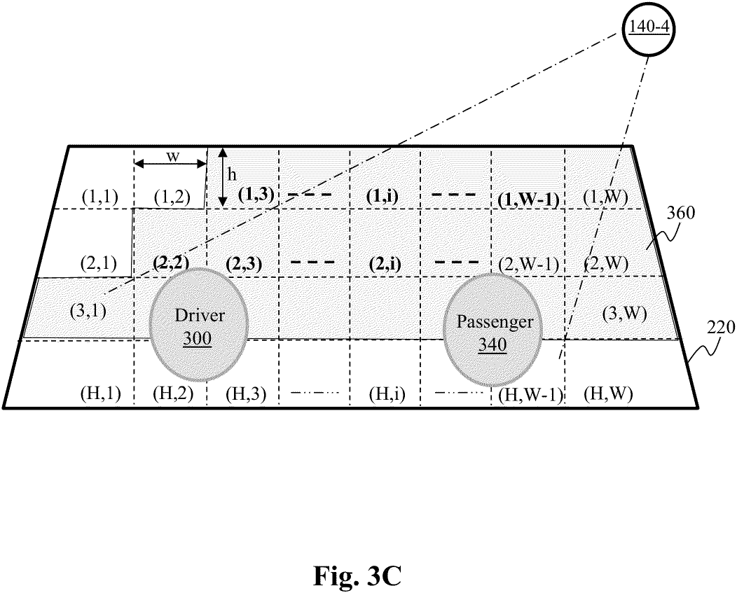

FIGS. 3A-3B show exemplary layout of a window of a vehicle with individually controllable elements for blocking sun light, in accordance with an embodiment of the present teaching. In FIG. 3A, an exemplary window, say front window 220, comprises a matrix of sections, e.g., H rows, each of which has w sections, with labels (1, 1), (1, 2), ..., (1, w-1), (1, w), (2, 1), ..., (2, w), ..., (H, 1), (H, 2), ..., and (H, w). Each of these sections are addressable, selectable, activatable, and controllable as to tint level. In FIG. 3A, an example is shown with the sun 140-4 located at the right side of the vehicle and a driver 300. To block the sun light for the driver 300, the rays of the sun light, including 310, ..., and 320, emitting from the sun and shine on the driver are estimated. Such rays intercept the window 220. Sections in window 220 may be identified so long as any of the sun light rays intercepts any point of such sections. The scope of the rays that are used to determine the sections may be limited by the scope of a part of the body of the driver 300. For instance, if it is known which portion of the driver for which a shield to be formed needs to block the sun light, then the scope of the shield may be determined. As shown in FIG. 3A, if what needs to be shielded from the sun light is the face of the driver, then the perimeter of the face may be used to determine the sections on the window to be used to form the shield. For example, rays of the sun light shining on points along the perimeter may be identified and their intersection points on the window may be used to identify sections. In this illustrated example, the rays from the sun 140-4 that reach the surroundings of the face of the driver 300 intersect several sections on the window, including (1,3), (1, 4), ..., (1, w+1), (2, 2), (2, 3), ..., (2, i), (2, i+1), (3, 1), (3, 2), ..., (3, i). Such selected sections may be applied to a certain tint level, shown in FIG. 3A as gray highlighted area.

FIG. 3B shows another example for identifying sections for blocking the light from the sun 140-4 with respect to a passenger 340 in the vehicle. Similarly to what is illustrated in FIG. 3A, sections (1, w-2), (1, w-1), (1, w), (2, i), ..., (2, w-1), (2, w), (3, i), (3, i+1), ..., (3, w) are identified based on a scope determined based on the face of the passenger 340. When a certain level of tint is applied, the selected sections form a shield 350 as highlighted in light gray in FIG. 3B. When both the driver 300 and the passenger 340 are present in the vehicle, a combined shield 360 may be formed by merge shield 330 and 350, which is shown in FIG. 3C. In these illustrations, the number of sections to be included may also depend on the height of the sun 140-4 in the sky. When the sun is up higher in the sky, the last row of the sections included in the combined shield 360 may not be needed.

While dynamic shield may be determined and formed based on detected presence of person/people in the vehicle, what is needed may also be determined based on configurations specified. For example, each person who may be in the vehicle may have a profile with an indication, e.g., whether he/she prefers to block the sun light. Some people may like to block the sun light and some may not. Such individualized preferences may be specified in each person’s profile. When the presence is detected, the person on each seat may be recognized, e.g., via face recognition, and appropriate profile may be invoked so that the preferences specified may be observed. For instance, if both a driver 300 and a passenger 340 are present in the vehicle. If the profile is the driver 300 specifies to have the sun light blocked when needed and the profile of the passenger 340 indicates not to block any sun light, then even though both people are present in the vehicle, the shield formed according to both people’s profiles will be for only the driver (same as shield 330 in FIG. 3A). Thus, dynamic shields for different people may be personalized based on specified preferences. As illustrated above, a shield can be dynamically formed in any shape needed based on need or preference.

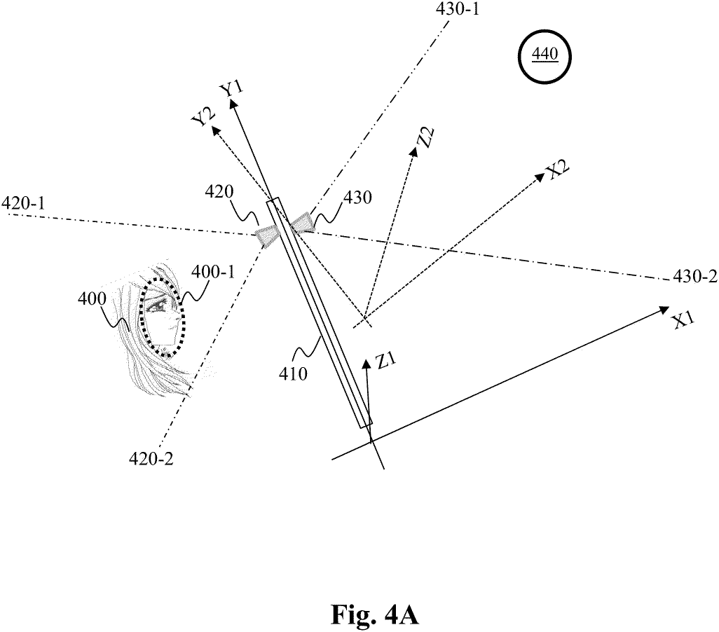

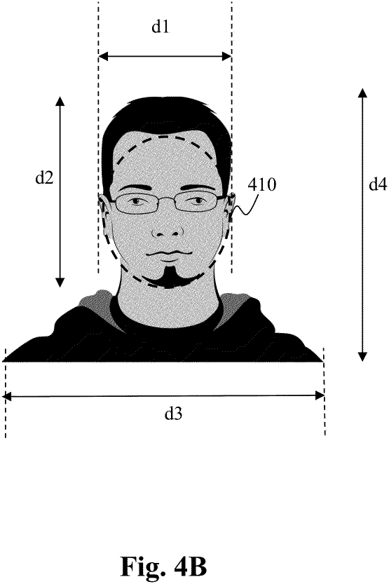

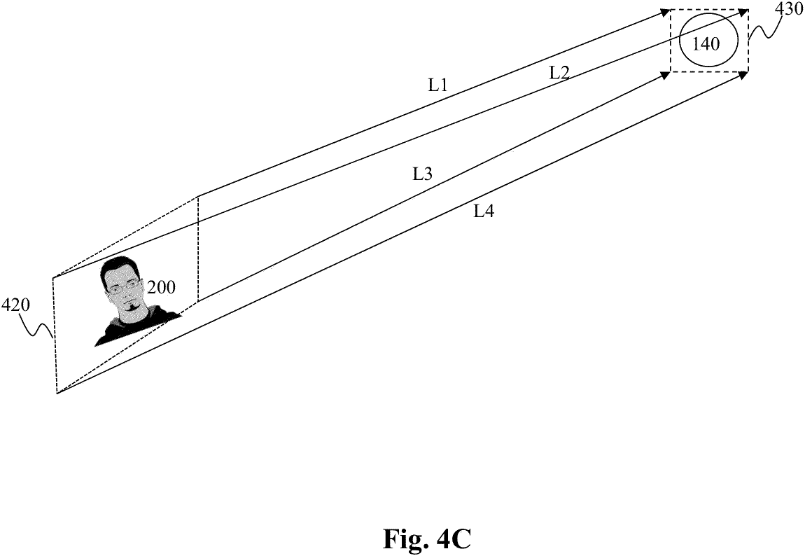

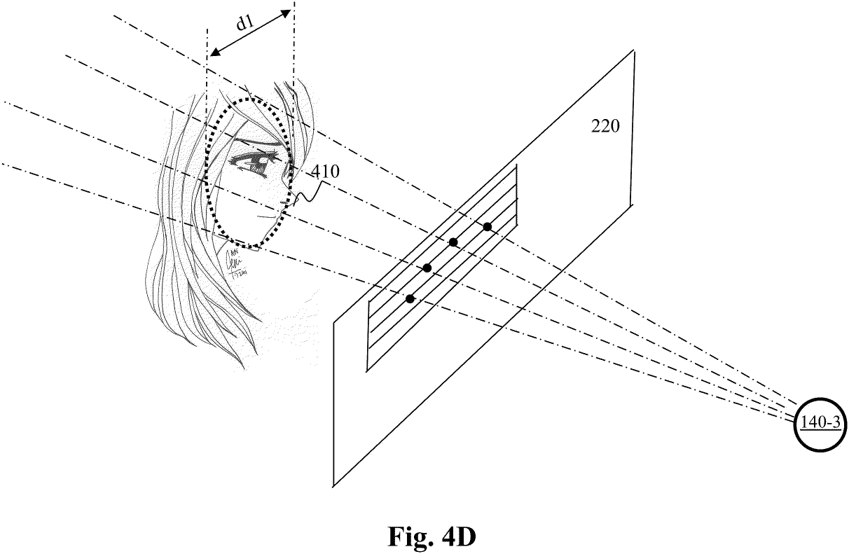

FIG. 4A depicts an exemplary configuration to detecting the direction of the sun and that of a person in a vehicle, in accordance with an exemplary embodiment of the present teaching. In this illustrated configuration, a person 400 sitting on one side of a window 410 and with a face 400-1. On the other side of window 410, there is sun 440, shining light onto the person 400 through the window 410. As discussed herein, to block the sun light, the direction of the sun and the direction of the person (e.g., the person’s face) may be detected and the rays of lights from the sun 440 towards the person 400 (or the face thereof) are estimated so that their intersection points with the window 410 may be identified. Based on such identified intersection points on window 410, sections on the window 410 may be located for applying a certain level of tint.

To enable estimations of directions of the sun and the person, the configuration shown in FIG. 4A comprises sensors 420 and 430 on both sides of the window 410, which may be cameras. In this embodiment, the sensor 420 on one side of the window 410 within the vehicle may be configured for detecting the presence and direction of a person within its field of view represented by 420-1 and 420-2. The sensor on the other side of the window 410 which is outside of the vehicle may be configured for detecting the direction of the sun 440. Each of the sensors and the window has its own corresponding coordinate system. For instance, window 410 has its coordinate system, marked as X1-Y1-Z1, which is set up so that window 410 is on a two-dimension plane of the coordinate system X1-Y1-Z1 at x1 = 0. That is, any point on window 410 has a coordinate (0, y1, z1). Each of the sensors may also have its own coordinate system. For example, sensor 430 may have a coordinate system represented by X2-Y2-Z2 and sensor 420 may have its own coordinate system X3-Y3-Z3 (not shown due to space limitation).

Transformation matrices may be provided by calibrating with respect to the three coordinate systems (i.e., X1-Y1-Z1, X2-Y2-Z2, and X3-Y3-Z3) that enable transformation or mapping of a coordinate in one coordinate system to a transformed coordinate in another coordinate system. Through such transformation, a coordinate representing a person (or face thereof) detected within the coordinate system of camera 420 (X3-Y3-Z3, not shown) may be transformed to a coordinate in the window’s coordinate system X1-Y1-Z1. Similarly, the coordinate of the sun 440 detected in the coordinate system X2-Y2-Z2 of camera 430 may also be transformed into a coordinate in the window’s coordinate system X1-Y1-Z1. With the coordinates of the sun 440 and the person 400 are mapped, via transformation, to the X1-Y1-Z1 coordinate system of the window 410, then the lines connecting the transformed coordinate of the sun and the transformed coordinate of the person (or face thereof) can be established in the coordinate system X1-Y1-Z1 and the points on such lines that intersect with the window at x1-0 (where the window is) can be determined. The sections on the window where any of such intersection points falls within may be selected for application of tint.

To determine a 3D coordinate of an object (e.g., a person’s face in the vehicle) in a coordinate system of a camera based on a 2D location in an image acquired by the camera, a depth measure needs to be estimated based on, e.g., either a depth sensor or stereo using multiple cameras. An object of interest detected from a 2D image may be represented by a 2D image coordinate, which may be determined based on, e.g., the centroid of a region of interest (ROI) in the image where the object of interest is detected. When there is another view of the same scene captured by another stereo camera, a corresponding 2D image coordinate in the other view may be detected to represent the same object. A discrepancy or displacement between the 2D image coordinate and the corresponding 2D image coordinate can be used to estimate the depth of the object in the 3D space. Alternatively, a depth sensor may be deployed in the vehicle to observe the same scene. When calibrated properly, a region from the depth map of the depth sensor that corresponds to the ROI in the image (representing a person’s face) may be identified and the depth measures in that region of the depth map may be used to estimate the depth of the person.

In an alternative embodiment, depth information may not be estimated but configured according to the setting of the present teaching. For example, the depth of the sun is known to be very far so that the depth for its depth may be set with a very large value. On the other hand, depending on the vehicle type (e.g., a car, a truck, a boat, etc.), the depth of the person detected behind the front window 410 may be set within a certain range. For instance, for a car, the distance from the camera 420 to the person sitting in the front row may be set to be 3 feet. While for a bus, that distance may be set bigger. Based on such set depths for the person detected and the sun, the 3D coordinates in their respective coordinate systems may be computed accordingly based on the corresponding 2D mage coordinates and the calibration parameters of their respective cameras. In this alternative embodiment, deploying a single camera on either side of the window 410 is sufficient so that the computational process to estimate the 3D coordinates of the objects of interest in respective coordinate systems is more efficient.

A region of interest may be defined according to the present teaching as the area of a person to be protected from the sun light. In some embodiments, such a region of interest may be defined as the face of the person sitting in a vehicle, as shown in FIG. 4B. The face 410 of a person may be detected from an image capture the surrounding of the person and a bounding box of the detected face may be established. In some embodiments, an area of interest in an 2D image capturing a person may also include the part of the person beyond the face. In the example shown in FIG. 4B, the area of a person to be protected from sun light may also include the upper body which is, e.g., extended from the face to below the neck. Such a region of interest may also be represented by a bounding box.

In some embodiments, to determine the intersection points on the window, 2D image coordinates of some points (e.g., on the boundary of a bounding box enclosing the object) of the sun may be converted into corresponding transformed coordinates in the coordinate system X1-Y1-Z1. Similarly, 2D image coordinates of some points of a region of interest of the person in the vehicle (e.g., on the boundary of a bounding box enclosing a region of interest related to the person) may be converted into corresponding transformed coordinates in the coordinate system of the window 410. This creates two clusters of 3D points in X1-Y1-Z1. One cluster has all 3D points with transformed coordinates converted from some points of 2D image points of the sun that have positive x coordinate values, indicating that they are outside of window 410. Another cluster has all 3D points in their transformed coordinates converted from some 2D image points of the person that have negative x values, indicating that they are inside the window 410.

To determine window sections to be used to apply tint for appropriately blocking the sun light for the person, the intersection points of lines (connecting a 3D point from the sun and a 3D point of the person) at x = 0 (where the window is located) can be identified. As what is important is a range for the spatial coverage, only a portion of the such lines may be used to elect sections. If a person has a preferred spatial range for sun light blocking, e.g., only face area or face plus neck area, this preferred spatial range may be specified in a profile for the person. A preferred range may be individualized for each person and a profile so specified may be translated into a bounding box around the person that is dimensioned according to the profile. This is illustrated in FIG. 4B.

If the specified preferred range is for face area, the dimension of the face may be estimated based on, e.g., camera data when the person is detected. In FIG. 4, the width of the face may be estimated to be d1 and the length of the face may be estimated to be d2. Given that, a bounding box with a dimension of d1×d2 may be determined and various sample 3D points on the boundary of the bounding box may be determined based on the estimated 3D face location. As another example, if a person’s preferred range is to cover from the face to shoulder, then the relevant dimension measures for that range may be estimated. FIG. 4B shows that the width of a person’s shoulder may be estimated to be d3 and the height from the shoulders to the top of the head may be estimated to be d4 so that a bounding box of d3×d4 may be derived and used to determine the lines connecting to the sun in order to determine the window sections. Similarly, the sun can also have a bounding box so that the scope of lines connecting the two may be determined.

FIG. 4C shows how bounding boxes may be used to determine the scope of relevant rays of sight between a person in a vehicle and the sun, in accordance with an embodiment of the present teaching. In some embodiments, key points on a boundary of a bounding box of an object of interest may be used for specifying a coverage of sun blocking for a person. For instance, the four corner points on a boundary box of a person’s upper body may be used to delineate the scope of the coverage. As illustrated in FIG. 4C, there is a bounding box 420 around a person 200 detected in the vehicle. As discussed herein, the size of the bounding box may be determined based on, e.g., a preferred scope of coverage of protection from the sun specified by, e.g., individuals, so that the present teaching can be applied in a personalized manner. As to the sun 140, the bounding box 430 may be just as big as the scope of the sun. Once the bounding boxes are determined, to derive the scope of the rays of lights, the four corners of the bounding box 420 for the person may be used as the outer range of the rays of lights from the sun that need to be blocked. Given that, connecting the points on the four corners of bounding box 420 with the points on the points on the four corners of the bounding box 430 yields four rays of light L1, L2, L3, and L4. These four rays of lights may represent the scope of the rays of lights from the sun to the person and may be used to determine the scope of the sections on the window(s) that need to be tinted to block the undesired sunlight on a portion of the body of the person 200.

FIG. 4D illustrates how appropriate sections of a front window in a vehicle may be determined for blocking sun light to a person in the vehicle, in accordance with an embodiment of the present teaching. Assume that the person as illustrated in FIG. 4D desires to protect only the face area 410 from the sun light. In this case, the bounding box for the face area may cover only the facial area of the person. In this illustration, rays of light from the sun shining on different points on the face (either on the boundary of the bounding box of the face 410 or within the bounding box) intersect the front window 220 at different intersection points on the window 220. As discussed herein, all such intersection points have x = 0 in the coordinate system of the front window 220. Some sections on the front window may be selected so long as there is at least one intersection point created by the rays of light connecting the sun with the person’s face. In this way, the rays of light connecting the four corners of the bounding box for the face to the outer boundary of the bounding box for the sun may yield sections on the front window 220 that define the scope of the outer boundary of the sections on the window to be activated to apply tint.

In some situations, such as what is shown in FIGS. 2E, 2G, 2I, and 2J, the intersections of the rays of light may fall on the left window 210 or the right window 230 of the vehicle. In these situations, the coordinates of the two end points of each such ray of light may be first converted into corresponding coordinates in the coordinate system of the left/right window, whichever one applies, before the intersection point (yielded by such a ray of light) on the left/right window may be determined. In this manner, no matter on which window panel any of the ray of light falls on, appropriate sections of the window(s) may be determined. The above described aspects of the present teaching may be implemented via an application deployed in the computerized system of the vehicle or can be an add-on module acquired separate from the vehicle and installed on the vehicle with interactions with sensors either deployed already on the vehicle or installed with the add-on module. In addition, although the disclosure herein uses the light from the sun as example for light blocking, any light from any source, either natural or man-made, that needs to be blocked for a person in a vehicle may blocked using the present teaching.

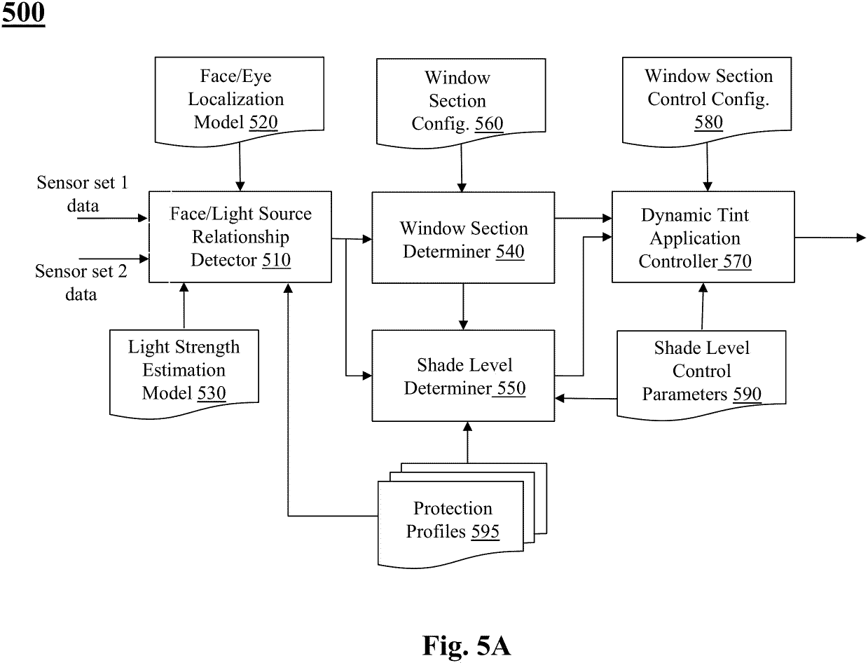

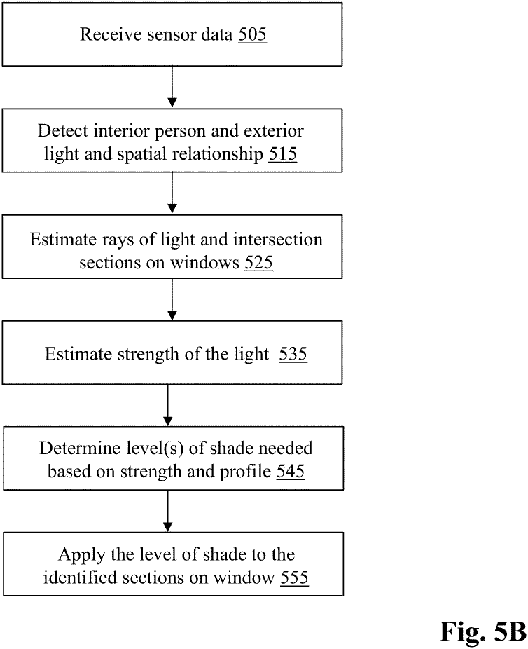

FIG. 5A depicts an exemplary high-level system diagram of an automated smart light blocking mechanism 500 for adaptive light blocking, in accordance with an exemplary embodiment of the present teaching. In this illustrated embodiment of the present teaching, the automated smart light blocking mechanism 500 comprises a face/light source relationship detector 510, an intersection section determiner 540, a shade level determiner 550, and a dynamic tint application controller 570. FIG. 5B is a flowchart of an exemplary process of the automated smart light blocking mechanism 500 for adaptive light blocking, in accordance with an exemplary embodiment of the present teaching. In operation, the face/light source relationship detector 510 receives, at 505 of FIG. 5B, data from sensors. This includes the sensor data from a first set of sensors located at the exterior of the vehicle for acquiring data related to the light source (e.g., the sun) and the sensor data from a second set of sensors deployed at the interior of the vehicle for acquiring data related to a person to be protected from the light (e.g., a driver or a passenger). Based on the sensor data, the face/light source relationship detector 510 detects, at 515, the person inside of the vehicle and the light source located outside of the vehicle and the spatial relationship between the two.

Once the person and the light source and their spatial relationship are detected, the intersection section determiner 540 estimates, at 525, the rays of lights connecting the points from the light source and the person and determine the intersection sections on the relevant window(s), as discussed herein. In the situations as depicted in FIGS. 2E, 2G, 2I - 2J, where light from the light source (such as sun) shines on multiple windows, the intersection sections on each of the windows may be determined separately according to what is disclosed with respect to FIGS. 4A - 4D. To accommodate the scenarios where multiple windows are involved in blocking the light, each of the windows may have its own coordinate system in which the window aligns with one axis at zero. Coordinates of points forming each ray of light may need to be converted into coordinates in each of the coordinate systems for the windows. Rays may intersect with windows in their corresponding coordinate systems, only the intersection points that have a zero value in a coordinate system of a particular window may be used to select window sections for blocking the light.

For example, in a scenario such as depicted in FIG. 2E where there are illustrated two rays R1 and R2 from the sun. R1 and R2 have their points represented by 3D coordinates in both coordinate systems for the front window 220 and the left window 210, respectively. Because a coordinate system for a window is set up to have the window align with an axis so that all points on the window have 3D coordinates with value zero with respect to that axis, each ray will intersect with one window when both a point on the ray and a point on the window have a zero value with respect to the axis. In the illustration provided in FIG. 2E, it is clearly that R1 intersects only with the left window 210. Although points on R1 can also have 3D coordinates in the coordinate system for the front window 220, there are all beyond the physical area where the front window reside. Given that, R1 does not intersect with the front window 220. Therefore, whenever there are multiple window present, the rays of light may be represented by 3D coordinates in different coordinate systems for such windows and the intersection will be detected in only one so that sections in the intersecting window may be identified.

In order to determine the scope of coverage as well as the level of protection to be applied, there may be multiple considerations, including the preference of the person detected and the strength of the light detected. The preference of the person may be specified in a profile stored in a storage 595. For instance, the preference of a person may include a specification of a spatial range of the person to be protected from the light (e.g., eyes only, face only, face plus neck, or face plus shoulder, etc.) and the level of protection (e.g., slight, medium, or heavy). Such preference is to be considered in the process of determining both the sections of the window(s) to be tinted and the level of tint to be applied.

To detect the strength of the light, the face/light source relationship detector 510 may also estimate, at 535, the strength of the light based on sensor data. In some embodiments, the level of shade needed may also be determined based on other factors. For example, not only the shade needed depends on the detected strength of the light, it also depends on, e.g., the preference of the person detected. Such personalized preference profile may be stored in 595 and is used by the shade level determiner 550 to estimate the level of shade needed for the person. Additional information that may be relevant to the determination of the shade level needed may include some control parameters, e.g., stored in a shade level control parameter storage 590, that specify the parameters needed to realize a level of shade desired given a level of strength of the light observed. The shade level determiner 550 thus determines, at 545, the level of shade needed based on the detected strength of light (from 510) and the parameters specified for shade level control with respect to detected strength of light.

With the sections on the window(s) selected (by 540) based on rays of light between the person and the light source in a spatial protection range (preferred protection range) as well as the estimated shade level needed to meet the desired level of protection of the person given the strength of the light detected, the dynamic tint application controller 570 applies, at 555, a necessary level of tint to the selected sections on the window(s) to block the light over the preferred protection range of the person. The application of the tint on the sections may be performed based on the shade control parameters from 590 and the configuration of the sections to be tinted. For example, the sections comprising the relevant window(s) may be electrically wired in a certain manner that will affect how to apply the tint. In some embodiments, sections of a window may be electrically connected in a row-based fashion and in this case, selection of needed sections may be performed by selectively activating some desired columns for applying the tint. In some embodiments, sections on relevant window(s) may be electrically connected in a column-based fashion so that selection of needed sections for applying tint may be through selectively activating certain rows.

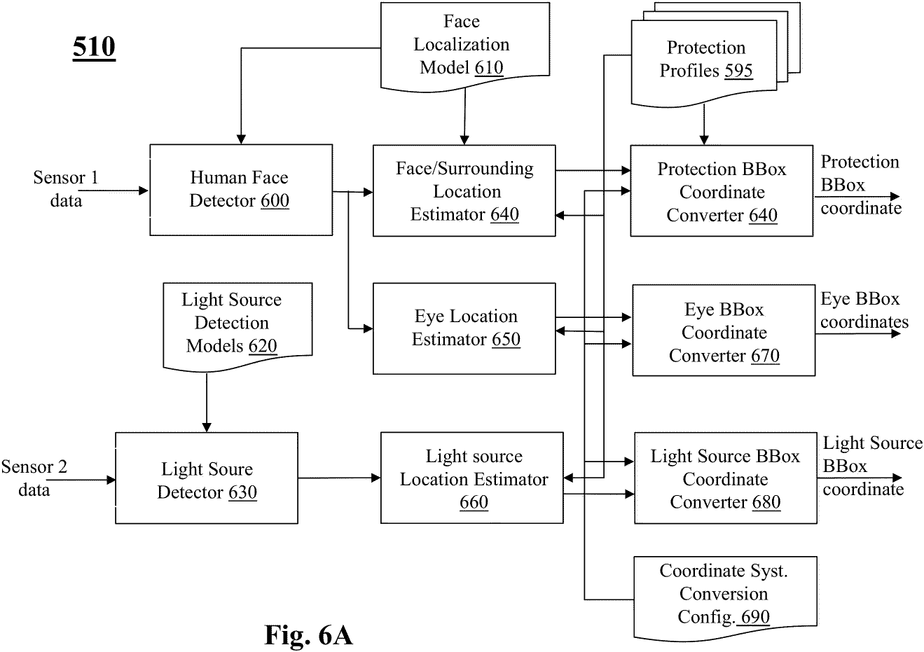

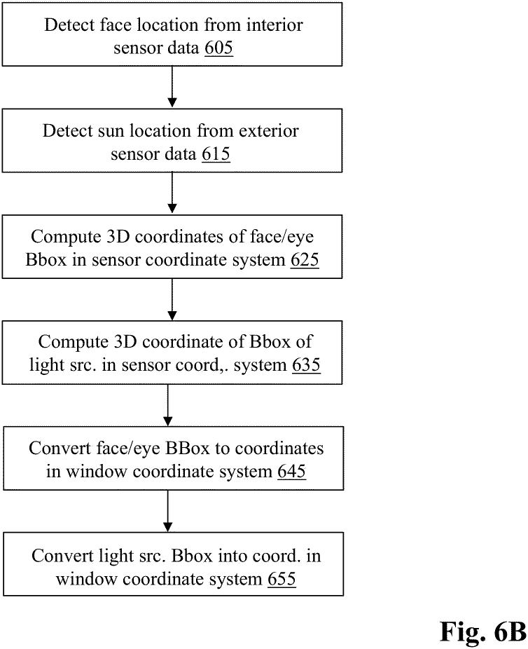

FIG. 6A depicts an exemplary high-level system diagram of the face/light source relationship detector 510, in accordance with an exemplary embodiment of the present teaching. In this illustrated embodiment, the face/light source relationship detector 510 takes sensor data as input and outputs specification of ranges of the person and the light source, e.g., via bounding boxes, so that they can be used by the intersection section determiner 540 to identify sections on relevant window(s) to be tinted. As discussed herein, the bounding box of a person in the vehicle may be determined based on, e.g., individualized preferences on the protection range, which may be eyes only, face only, face plus neck, or face plus shoulder, etc. Given that, the output bounding boxes may vary in range with respect to individuals detected.

In this illustrated embodiment, the face/light source relationship detector 510 comprises a human face detector 600 and a light source detector 630 for detecting the presence of a person (or people) or a light. The human face detector 600 is configured to detect presence of a person based on his/her face. In some embodiments, the human face detector 600 may also be configured to detect the identity of the person present in the vehicle (not shown in FIG. 6A). In some situations, recognizing the identity of a person present in the vehicle may be needed in order to, e.g., invoke a personal profile relevant to the very person detected so that personalized protection from the sun light may be implemented based on a specification from the protection profiles 595. Similarly, the light source detector 630 may detect a light based on some light source detection models 620. Depending on the specific light to be detected, e.g., the sun light or the light from a man-made light source, the light source detector 630 may invoke an appropriate detection model from 620 to facilitate its detection. In terms of which model to invoke may be determined, e.g., based on time of a day or a specific instruction from, e.g., a person present in the vehicle (not shown).

Detection of a human face or a light source have been widely used in literature. Some of such techniques may utilize artificial intelligence technologies such as machine learning that produces trained models to facilitate detection of certain objects. For example, the human face detector 600 may perform the detection based on some face location models 610 that are trained, e.g., via learning, to recognize presence of color of human faces from, e.g., images. Similarly, depending on what type of light source to be detected, the light source detector 630 may invoke an appropriate model to facilitate the detection. For instance, if it is to detect a sun light from, e.g., images acquired by cameras installed outside of the front window 220, models previously trained for detecting presence of sun light from images may be used for the detection.

With detected objects of interest, coordinates of such detected objects may be determined with respect to their respective coordinate systems. For doing so, the face/light source relationship detector 510 includes a face surrounding location estimator 640, an eye location estimator 650, and a light source location estimator 660. The face surrounding location estimator 640 and the eye location estimator 650 may be invoked to identify bounding boxes according to a specified protection profile for the person detected. For instance, the protection profile may specify to protect only the eyes, the face, the face plus neck, etc. The profile is accessed from the protection profile storage 595 and used to determine the type of bounding box to be estimated. The face surrounding estimator 640 is to identify the bounding box related to the face of the person according to the protection profile of the person. The eye location estimator 650 is invoked when only eye area is to be protected according to the protection profile. The light source location estimator 660 is invoked to identify a bounding box for the light source detected from the image.

With the bounding boxes identified for different objects of interest and represented by the coordinates in the respective coordinate systems of the sensors, such coordinates need to be converted to the coordinates in the coordinate system(s) of the relevant window(s). To do so, the 510 further includes a protection BBox coordinate converter 640, an eye BBox coordinate converter 670, and a light source BBox coordinate converter 680. Each conversion is performed with respect to the transformation parameters stored in the coordinate system conversion configuration 690. The protection BBox coordinate converter 640 outputs face-based protection BBox coordinates expressed with respect to the coordinate system(s) of the relevant window(s). The eye BBox coordinate converter 670 outputs eye BBox coordinates expressed with respect to the coordinate system(s) of the relevant window(s). The light source BBox coordinate converter 680 outputs light source BBox coordinates expressed with respect to the coordinate system(s) of the relevant window(s).

FIG. 6B is a flowchart of an exemplary process of the face/light source relationship detector 510, in accordance with an exemplary embodiment of the present teaching. Based on sensor data, the human face detector 600 detects, at 605, presence of a face of a person. As discussed herein, in some embodiments, the human face detector 600 may also perform face-based recognition by detecting the identity of the person. Based on sensor data from sensors located outside of the vehicle, the light source detector 630 detects, at 615, the presence of a light source. In some embodiments, absent of a specification of the protection, a default setting may specify that the protection area is the face or the eye area of the detected person. In a more complex setting, if the person’s identify is known (e.g., either via face recognition or any other form of recognition), a personal protection profile may be accessed and used to control the computation of the protection range. The face surrounding location estimator 640 may be invoked to compute, at 625, the 3D coordinates of the bounding box of the protection area related to the face, the face plus neck, or the face plus shoulder, etc. Such 3D coordinates are with respect to the coordinate system of the interior sensor(s). The eye location estimator 650 may, instead, be invoked to compute the 3D coordinates of the bounding box for the eyes of the person with respect to the interior sensors’ coordinate system. The light source location estimator 660 may be activated to compute, at 635, the 3D coordinates of the bounding box of the detected light source with respect to the coordinate system of the exterior sensors that capture the image of the light source.

With the coordinates of different objects of interest computed with respect to their respective coordinate systems, the protection BBox coordinate converter 640 converts, at 645, the coordinates of the bounding box for a protection area with respect to the coordinate system of the interior sensor(s) to that in the coordinate system of the window(s). Similarly, the eye BBox coordinate converter 640 converts the coordinates of the bounding box for the eye area with respect to the coordinate system of the interior sensor(s) to that in the coordinate system of the window(s). The light source BBox coordinate converter 680 converts, at 655, the coordinates of the bounding box for the light source with respect to the coordinate system of the exterior sensor(s) to that in the coordinate system of the window(s). In this way, all the coordinates of all the relevant bounding boxes are now represented in the coordinate system of the relevant window(s) to enable generation of rays of lights between the protection area (face, eyes, or more) and the light source. As discussed herein with respect to FIGS. 5A-5B, the intersection sections on the window(a) may then be determined and a certain tint level may be applied to the intersection sections to realize a dynamically determined windshield that protects the person (or people) from the light from the detected light source. The selection of the sections to be used to block the light may change in real-time on-the-fly according to the present teaching. In this manner, a person in a vehicle does not need to be bothered by the lights from changing directions and re-arrange the limited shields without achieving the desired protection.

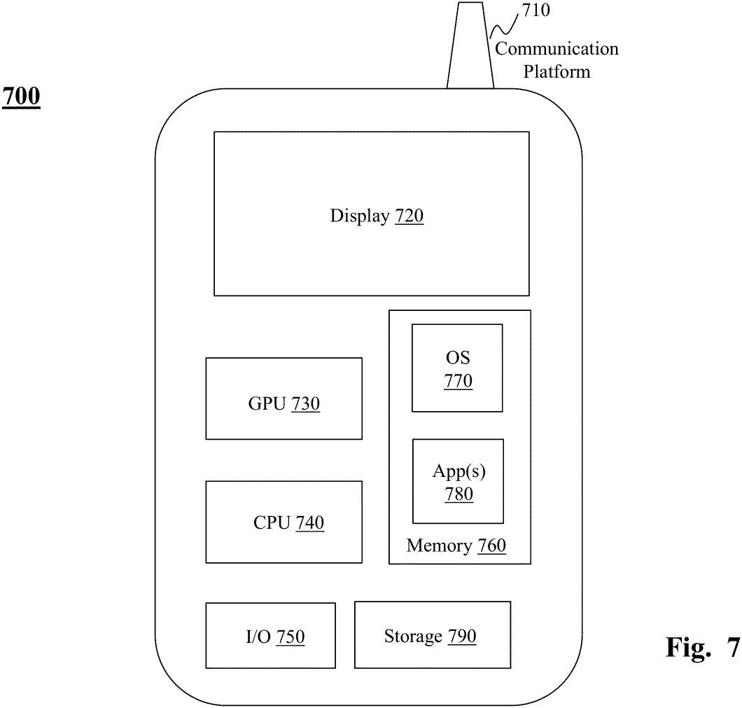

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but not limited to, a smart phone, a tablet, a music player, a handled gaming console, a global positioning system (GPS) receiver, and a wearable computing device, or in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.), and one or more applications 780 may be loaded into memory 760 from storage 790 in order to be executed by the CPU 740. The applications 780 may include a user interface or any other suitable mobile apps for information analytics and management according to the present teaching on, at least partially, the mobile device 700. User interactions, if any, may be achieved via the I/O devices 750 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

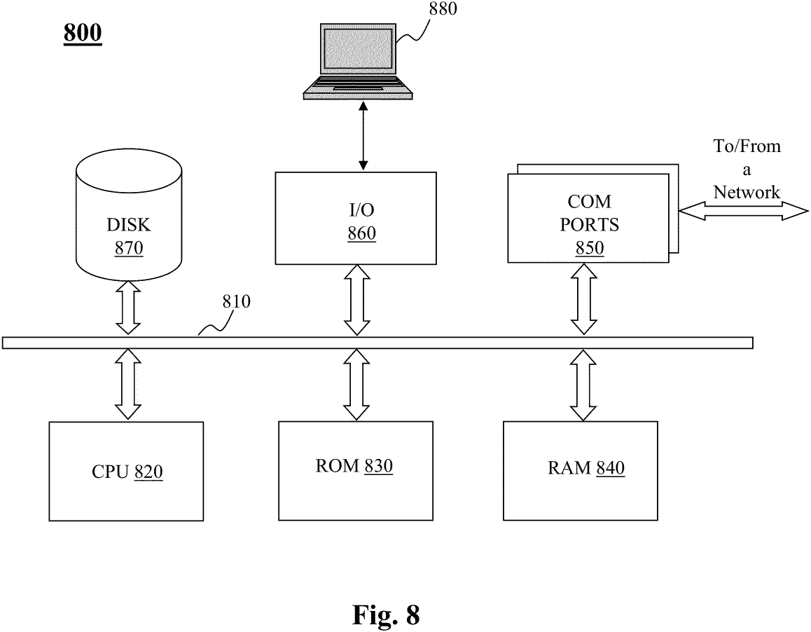

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information analytical and management method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of dialogue management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one processor, a memory, and a communication platform for dynamic light blocking, comprising:
receiving sensor data from sensors deployed on a vehicle, wherein the sensor data capture information exterior and interior around the vehicle;
detecting presence of a person in the vehicle based on interior sensor data;
detecting a light source exterior to the vehicle based on exterior sensor data;
determining a portion of a window of the vehicle through which light from the light source shines on the person; and
applying a level of shade on the portion of the window to reduce the amount of light shining on the person.

2. The method of claim 1, wherein
the presence of the person is identified via a first region of interest represented using a first set of three dimensional (3D) coordinates in a coordinate system;
the light source is identified via a second region of interest represented using a second set of 3D coordinates in the coordinate system; and
the coordinate system is configured so that the window is approximately aligned on one axis so that 3D coordinate of any point on the window has a zero or near zero value with respect to the axis.

3. The method of claim 2, wherein the first region of interest is determined based on at least one of:
a default profile specifying a designated part of a person to be protected from the light emitted by the light source;
a personal profile associated with the person specifying a preferred part of the person to be protected from the light emitted by the light source.

4. The method of claim 2, wherein
the window includes a plurality of sections, each of which occupies an identifiable area in the coordinate system; and
the portion of the window is defined by one or more of the plurality of sections of the window dynamically identified based on the first and the second regions of interest.

5. The method of claim 4, wherein
each of the plurality of sections of the window can be individually controlled to provide different levels of shade; and
each level of the different levels of shade is achieved by applying a level of tint.

6. The method of claim 2, wherein the step of determining the portion comprises:
establish rays of light connecting the first and the second sets of 3D coordinates and representing how the light from the light source shines on the first region of interest;
for each of the rays connecting one of the first set of 3D coordinates and one of the second set of 3D coordinates,
identifying a point on the ray that intersects with the window on the axis,
locating an intersecting section from the plurality of sections of the window in which the point falls; and
generating the portion of the window based on the intersecting sections identified based on the rays.

7. The method of claim 6, wherein the step of establishing the rays of light comprises:
identifying a first subset of the first set of 3D coordinates on boundary of the first region of interest;
identifying a second subset of the second set of 3D coordinates on boundary of the second region of interest, wherein the first and the second subsets include a same number of 3D coordinates;
for each 3D coordinate from the first subset,
identifying a corresponding 3D coordinate from the second subset, and
forming a ray of light.

8. Machine readable non-transitory medium having information recorded thereon for dynamic light blocking, wherein the information, once read by the machine, causes the machine to perform the following steps:
receiving sensor data from sensors deployed on a vehicle, wherein the sensor data capture information exterior and interior around the vehicle;
detecting presence of a person in the vehicle based on interior sensor data;
detecting a light source exterior to the vehicle based on exterior sensor data;
determining a portion of a window of the vehicle through which light from the light source shines on the person; and
applying a level of shade on the portion of the window to reduce the amount of light shining on the person.

9. The medium of claim 8, wherein
the presence of the person is identified via a first region of interest represented using a first set of three dimensional (3D) coordinates in a coordinate system;
the light source is identified via a second region of interest represented using a second set of 3D coordinates in the coordinate system; and
the coordinate system is configured so that the window is approximately aligned on one axis so that 3D coordinate of any point on the window has a zero or near zero value with respect to the axis.

10. The medium of claim 9, wherein the first region of interest is determined based on at least one of:
a default profile specifying a designated part of a person to be protected from the light emitted by the light source;
a personal profile associated with the person specifying a preferred part of the person to be protected from the light emitted by the light source.

11. The medium of claim 9, wherein
the window includes a plurality of sections, each of which occupies an identifiable area in the coordinate system; and
the portion of the window is defined by one or more of the plurality of sections of the window dynamically identified based on the first and the second regions of interest.

12. The medium of claim 11, wherein
each of the plurality of sections of the window can be individually controlled to provide different levels of shade; and
each level of the different levels of shade is achieved by applying a level of tint.

13. The medium of claim 9, wherein the step of determining the portion comprises:
establish rays of light connecting the first and the second sets of 3D coordinates and representing how the light from the light source shines on the first region of interest;
for each of the rays connecting one of the first set of 3D coordinates and one of the second set of 3D coordinates,
identifying a point on the ray that intersects with the window on the axis,
locating an intersecting section from the plurality of sections of the window in which the point falls; and
generating the portion of the window based on the intersecting sections identified based on the rays.

14. The medium of claim 13, wherein the step of establishing the rays of light comprises:
identifying a first subset of the first set of 3D coordinates on boundary of the first region of interest;
identifying a second subset of the second set of 3D coordinates on boundary of the second region of interest, wherein the first and the second subsets include a same number of 3D coordinates;
for each 3D coordinate from the first subset,
identifying a corresponding 3D coordinate from the second subset, and
forming a ray of light.

15. A system for dynamic light blocking, comprising:
a face/light source relationship detector implemented by a processor and configured for:
receiving sensor data from sensors deployed on a vehicle, wherein the sensor data capture information exterior and interior around the vehicle,
detecting presence of a person in the vehicle based on interior sensor data, and
detecting a light source exterior to the vehicle based on exterior sensor data;
a window section determiner implemented by a processor and configured for determining a portion of a window of the vehicle through which light from the light source shines on the person; and
a dynamic tint application controller implemented by a processor and configured for applying a level of shade on the portion of the window to reduce the amount of light shining on the person.

16. The system of claim 1, wherein
the presence of the person is identified via a first region of interest represented using a first set of three dimensional (3D) coordinates in a coordinate system;
the light source is identified via a second region of interest represented using a second set of 3D coordinates in the coordinate system; and
the coordinate system is configured so that the window is approximately aligned on one axis so that 3D coordinate of any point on the window has a zero or near zero value with respect to the axis.

17. The system of claim 16, wherein the first region of interest is determined based on at least one of:
a default profile specifying a designated part of a person to be protected from the light emitted by the light source;
a personal profile associated with the person specifying a preferred part of the person to be protected from the light emitted by the light source.

18. The system of claim 16, wherein
the window includes a plurality of sections, each of which occupies an identifiable area in the coordinate system; and
the portion of the window is defined by one or more of the plurality of sections of the window dynamically identified based on the first and the second regions of interest, wherein
each of the plurality of sections of the window can be individually controlled to provide different levels of shade, and
each level of the different levels of shade is achieved by applying a level of tint.

19. The system of claim 16, wherein the window section determiner determines the portion by:
establishing rays of light connecting the first and the second sets of 3D coordinates and representing how the light from the light source shines on the first region of interest;
for each of the rays connecting one of the first set of 3D coordinates and one of the second set of 3D coordinates,
identifying a point on the ray that intersects with the window on the axis,
locating an intersecting section from the plurality of sections of the window in which the point falls; and
generating the portion of the window based on the intersecting sections identified based on the rays.

20. The system of claim 19, wherein the rays of light are identified by:
identifying a first subset of the first set of 3D coordinates on boundary of the first region of interest;
identifying a second subset of the second set of 3D coordinates on boundary of the second region of interest, wherein the first and the second subsets include a same number of 3D coordinates;
for each 3D coordinate from the first subset,
identifying a corresponding 3D coordinate from the second subset, and
forming a ray of light.
